(19) United States
(12) Patent Application Publication
(10) Pub. No.: US 2026/0177891 A1
(43) Pub. Date: Jun. 25, 2026

(54) CAMERA ASSEMBLY AND IMAGING APPARATUS

(71) Applicant: SHARETRONIC DATA TECHNOLOGY CO., LTD., Shenzhen City (CN)

(72) Inventors: Kangming GENG, Shenzhen City (CN); Zhou YI, Shenzhen City (CN); Zhaotian QU, Shenzhen City (CN); Jianfei LIU, Shenzhen City (CN); Chunyun CHEN, Shenzhen City (CN)

(21) Appl. No.: 19/317,809

(22) Filed: Sep. 3, 2025

(30) Foreign Application Priority Data
Dec. 24, 2024 (CN) 202423226685.X

(51) Int. Cl. G03B 17/56

(52) U.S. Cl. CPC G03B 17/561

(57) ABSTRACT

The present disclosure provides a camera assembly and an imaging apparatus. The camera assembly includes a camera body and a front cover. The front cover defines a receiving space. An end portion of the camera body is at least partially mounted in the receiving space. A snap-fit structure is provided at a junction between the camera body and the front cover. The snap-fit structure includes an elastic snap-fit member and a plurality of snap grooves arranged peripherally. When the elastic snap-fit member engages with different snap grooves, the camera body is positioned at different angles relative to the front cover. After the camera assembly of the present disclosure is fixed to the substrate, the angle of the camera body can be adjusted directly via the snap-fit structure without needing to detach and realign the entire camera assembly, which allows users to mount and use the camera assembly more conveniently and efficiently.

### CROSS-REFERENCE TO RELATED APPLICATIONS

The present disclosure claims priority under 35 U.S.C. § 119(a) to Chinese Application Patent Application No. 202423226685.X, filed on Dec. 24, 2024, the entire disclosure of which is hereby incorporated by reference.

### TECHNICAL FIELD

The present disclosure relates to imaging technology, and in particular relates to a camera assembly and imaging apparatus.

### BACKGROUND

With the advancement of technology, cameras are widely used in various scenarios. However, certain cameras need to be fixed onto a light-transmitting substrate before use. In existing technologies, once a camera is mounted on such a light-transmitting substrate, an angle of the camera cannot be adjusted afterward. Instead, the camera must be removed, realigned, and then reattached to the light-transmitting substrate. This makes mounting and usage inconvenient for users, requiring significant time and effort, ultimately degrading user experience and satisfaction.

### SUMMARY

Embodiments of the present disclosure provide a camera assembly and imaging apparatus, to solve at least part of the aforementioned technical problems.

In a first aspect, the present disclosure provides a camera assembly, including: a camera body, and a front cover, the front cover defining a receiving space, an end portion of the camera body being at least partially mounted in the receiving space; where a snap-fit structure is provided at a junction between the camera body and the front cover, the snap-fit structure may include an elastic snap-fit member and a plurality of snap grooves arranged peripherally around the camera assembly; when the elastic snap-fit member engages with different snap grooves, the camera body is positioned at different angles relative to the front cover.

In a second aspect, the present disclosure provides an imaging apparatus, including the aforementioned camera assembly, and a fixing member mounted on an outer side of the front cover to secure the camera assembly to a substrate.

The present disclosure provides the camera assembly and imaging apparatus. The camera assembly includes a camera body and a front cover. The front cover defines a receiving space, and an end portion of the camera body is at least partially mounted in the receiving space. A snap-fit structure is provided at a junction between the camera body and the front cover, including an elastic snap-fit member and a plurality of snap grooves arranged peripherally around the camera assembly. When the elastic snap-fit member engages with different snap grooves, the camera body is positioned at different angles relative to the front cover. The imaging apparatus includes the aforementioned camera assembly and a fixing member mounted on the outer side of the front cover to secure the camera assembly to a substrate. After the camera assembly of the present disclosure is fixed to the substrate, the angle of the camera body can be adjusted directly via the snap-fit structure without needing to detach and realign the entire camera assembly, which allows users to mount and use the camera assembly more conveniently and efficiently, saving time and effort while improving user experience and satisfaction.

### BRIEF DESCRIPTION OF THE ACCOMPANYING DRAWINGS

To describe the technology solutions in the embodiments of the present disclosure more clearly, the following briefly introduces the accompanying drawings required for describing the embodiments. Obviously, the accompanying drawings in the following description show merely at least one embodiment of the present disclosure, those of ordinary skilled in the art may also obtain other drawings based on these drawings without any creative efforts.

FIG. 1 is a schematic perspective view of an imaging apparatus fixed to a substrate in accordance with at least one embodiment of the present disclosure;

FIG. 2 is an exploded view of FIG. 1;

FIG. 3 is a schematic perspective view of a camera assembly in accordance with at least one embodiment of the present disclosure;

FIG. 4 is an exploded view of FIG. 3;

FIG. 5 is an enlarged view of FIG. 4 taken along a circle A;

FIG. 6 is a schematic perspective view of the camera assembly in accordance with at least one embodiment of the present disclosure from another view;

FIG. 7 is a cross-sectional view of the front cover and body housing in FIG. 6 taken along a line B-B;

FIG. 8 is an enlarged view of FIG. 7 taken along a circle C;

FIG. 9 is a perspective view of FIG. 7 from another view;

FIG. 10 is an enlarged view of FIG. 9 taken along a circle D;

FIG. 11 is a schematic perspective view of a camera body in accordance with at least one embodiment of the present disclosure;

FIG. 12 is a cross-sectional view of FIG. 3 taken along a line E-E;

FIG. 13 is an enlarged view of FIG. 12 taken along a circle F;

FIG. 14 is an exploded view of FIG. 6.

The reference numbers in the detailed description are as follows:
Imaging apparatus—100; Camera assembly—200; camera body—1; front cover—2; camera lens—13; mounting gap—14; charging port—15; front cover—2; receiving space—21; light-transmitting area—22; snap-fit structure—3; elastic snap-fit member—31; snap-fit grooves—32; side engagement portions—321; recess—322; step structure—4; step portion—41; protruding portion—411; mounting portion—412; latch portion—42; first latch—421; second latch—422; gap—423; positioning portion—43; protruding strip—44; fixed member—300; first fixed member—301; second fixed member—302; substrate—400.

### DETAILED DESCRIPTION OF ILLUSTRATED EMBODIMENTS

In order to enable those skilled in the technical field to better understand the solutions of the present disclosure, the technical solutions in the embodiments of the present disclosure will be described clearly and completely in the following with reference to the accompanying drawings in the embodiments of the present disclosure. Obviously, the described embodiments are only a part of the embodiments of the present disclosure, rather than all of them. Based on the embodiments in the the present disclosure, all other embodiments obtained by those of ordinary skill in the art without creative efforts shall fall within the protection scope of the present disclosure.

It should be understood that the terms “first”, “second”, etc. in the specification and claims of the present disclosure and the accompanying drawings are configured to distinguish different objects and are not configured to describe a particular order. In addition, the terms “include”, “include” and “have”, and any variations thereof, are intended to cover non-exclusive inclusion. For example, a process, method, system, product or device including a series of steps or units is not limited to the listed steps or units, but optionally also can include steps or units that are not listed, or optionally can include other steps or units that are inherent to the process, method, product or apparatus.

“Embodiments” in the present disclosure means that particular features, structures, or characteristics described with reference to the embodiments may be included in at least one embodiment of the present disclosure. The presence of the phrase at various places in the specification does not necessarily referring to the same embodiment, nor is it a separate or alternative embodiment that is mutually exclusive of other embodiments. It is understood by those skilled in the art, both explicitly and implicitly, that the embodiments described in the present disclosure may be combined with other embodiments.

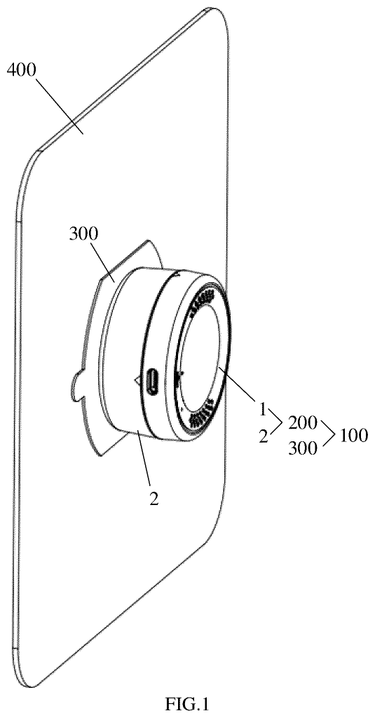

Please refer to FIG. 1. FIG. 1 is a schematic perspective view of an imaging apparatus 100 fixed to a substrate 400 in accordance with at least one embodiment of the present disclosure. The imaging apparatus 100 may include a camera assembly 200 and a fixed member 300. The fixed member 300 is mounted on an outer side of the front cover 2 to secure the camera assembly 200 to a substrate 400. The camera assembly 200 is configured for imaging, photography, and other functions.

Therefore, the camera assembly 200 can be fixed onto the substrate 400 via the fixed member 300, so as to enhance the stability of the camera assembly 200 during use.

In at least one embodiment, the substrate 400 is a light-transmitting substrate, which may include, but is not limited to, glass substrates, or light-transmitting substrates made of materials such as polycarbonate (PC), polymethyl methacrylate (PMMA), polyethylene terephthalate (PET), polystyrene (PS), polytetrafluoroethylene (PTFE), fluorinated ethylene propylene (FEP), polyimide (PI), sapphire, quartz, etc., or non-light-transmitting substrates, which is not limited herein.

In at least one embodiment, the fixed member 300 is double-sided adhesive tape. The front cover 2 is adhered and fixed onto the substrate 400 via the double-sided adhesive tape, thereby securing the camera assembly 200 onto the substrate 400.

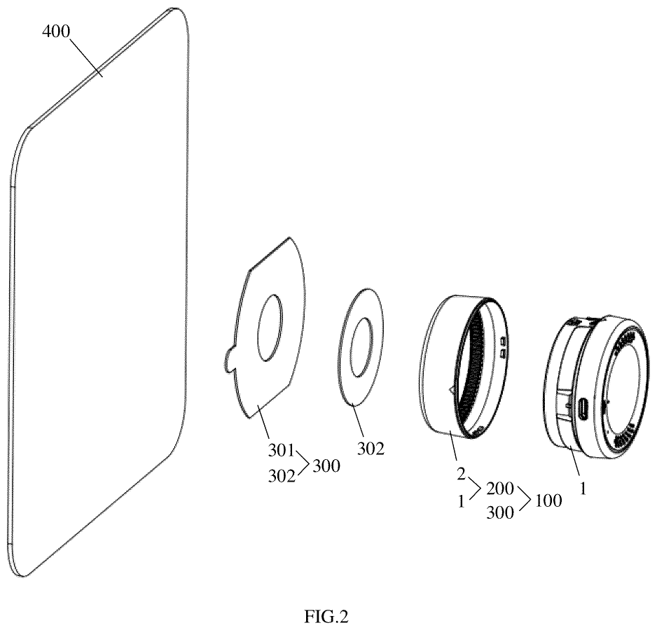

Please also refer to FIG. 2. FIG. 2 is an exploded view of FIG. 1. In at least one embodiment, the fixed member 300 is a hook-and-loop fastener (e.g., Velcro). The fixed member 300 includes a first fixed member 301 and a second fixed member 302. One side of the first fixed member 301 close to the substrate 400 is an adhesive surface, while the other side of the first fixed member 301 close to the camera assembly 200 is a loop surface. One side of the second fixed member 302 close to the substrate 400 is a hook surface, while the other side of the second fixed member 302 close to the camera assembly 200 is an adhesive surface.

Specifically, through the adhesive action of the adhesive surfaces, the first fixed member 301 is adhered to the substrate 400, and the second fixed member 302 is adhered to the front cover 2. Then, via the engagement of the loop surface and hook surface, the first fixed member 301 and the second fixed member 302 are connected together to secure the camera assembly 200 onto the substrate 400.

In other embodiments, the fixed member 300 is a snap-fit or other fixable element.

In yet other embodiments, the fixed member 300 may be omitted, and the camera assembly 200 may be fixed onto the substrate 400 using a vacuum suction method.

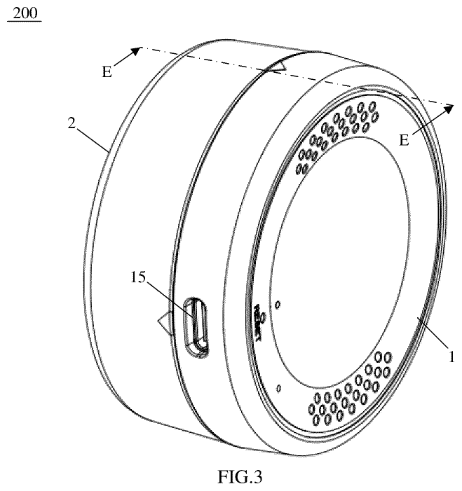

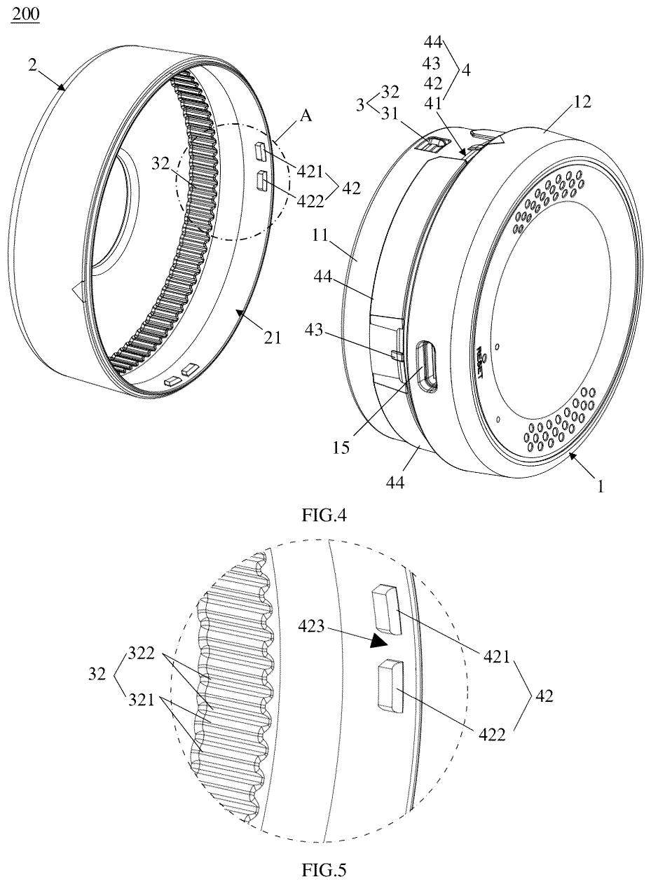

Please also refer to FIGS. 3-5. FIG. 3 is a schematic perspective view of a camera assembly 200 in accordance with at least one embodiment of the present disclosure. FIG. 4 is an exploded view of FIG. 3. FIG. 5 is an enlarged view of FIG. 4 taken along a circle A. The camera assembly 200 may include a camera body 1 and a front cover 2. The front cover 2 defines a receiving space 21, and at least part of one end of the camera body 1 is mounted within the receiving space 21. A snap-fit structure 3 is provided at a junction of the camera body 1 and the front cover 2. The snap-fit structure 3 may include an elastic snap-fit member 31 and a plurality of snap-fit grooves 32 arranged peripherally around the camera assembly 200. When the elastic snap-fit member 31 engages with different snap-fit grooves 32, the camera body 1 is positioned at different angles relative to the front cover 2.

Therefore, after the camera assembly 200 is fixed to the substrate 400, the angle of the camera body 1 can be directly adjusted via the snap-fit structure 3, which allows the angle of the camera body 1 to be adjusted independently within the camera assembly 200 without needing to remove the camera assembly 200 to adjust the overall angle of the camera assembly 200, and thus making it more convenient and quicker for users to mount and use the camera assembly 200, and saving mounting time and effort while also improving user experience and satisfaction.

In at least one embodiment, as shown in FIG. 4, the elastic snap-fit member 31 is located on an outer side of the camera body 1, and the plurality of snap-fit grooves 32 are defined on an inner sidewall of the front cover 2.

Therefore, when adjusting the angle of the camera body 1, the elastic snap-fit member 31 on the outer side of the camera body 1 sequentially engages with each of the plurality of snap-fit grooves 32 on the inner sidewall of the front cover 2, which allows the angle of the camera body 1 to be adjusted independently within the camera assembly 200 without needing to remove the camera assembly 200 to adjust its overall angle, thus making it more convenient for users to mount and use the camera assembly 200, and saving time and effort while enhancing user experience and satisfaction.

In other embodiments, the elastic snap-fit member 31 is located on the inner sidewall of the front cover 2, and the plurality of snap-fit grooves 32 are defined on the outer side of the camera body 1.

Therefore, when adjusting the angle of the camera body 1, the elastic snap-fit member 31 on the inner sidewall of the front cover 2 sequentially engages with each of the plurality of snap-fit grooves 32 on the outer side of the camera body 1, which allows the angle of the camera body 1 to be adjusted independently within the camera assembly 200 without needing to remove the camera assembly 200 to adjust its overall angle, thus making it more convenient for users to mount and use the camera assembly 200, and saving time and effort while enhancing user experience and satisfaction.

In at least one embodiment, as shown in FIGS. 4 and 5, the camera body 1 may include a body cover 12 and a body housing 11. An outer side of the body housing 11 is the aforementioned outer side of the camera body 1. The body housing 11 defines a body cavity. An opening of the body cavity faces away from the front cover 2. The body cover 12 is mounted on the body housing 11 to close the opening of the body cavity.

In at least one embodiment, a circuit board and a plurality of electronic components are mounted within the body cavity. The plurality of electronic components are mounted on the circuit board, which controls the camera body 1 to perform corresponding functions.

In at least one embodiment, as shown in FIG. 4, the camera body 1 defines a charging port 15, specifically located on the body cover 12 and connected to the circuit board within the body cavity to supply power to the circuit board and the plurality of electronic components.

It should be understood that the charging port 15 may be a Type-A, Type-C, or other type of interface, without limited herein.

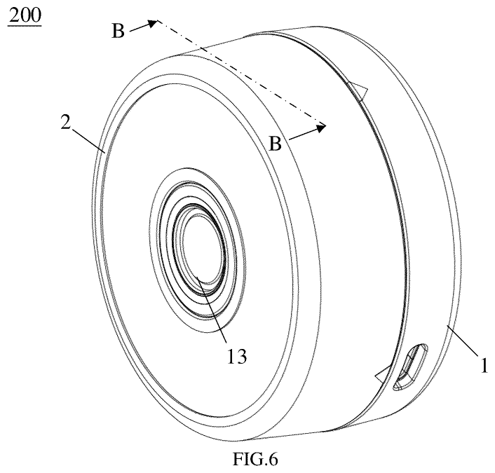

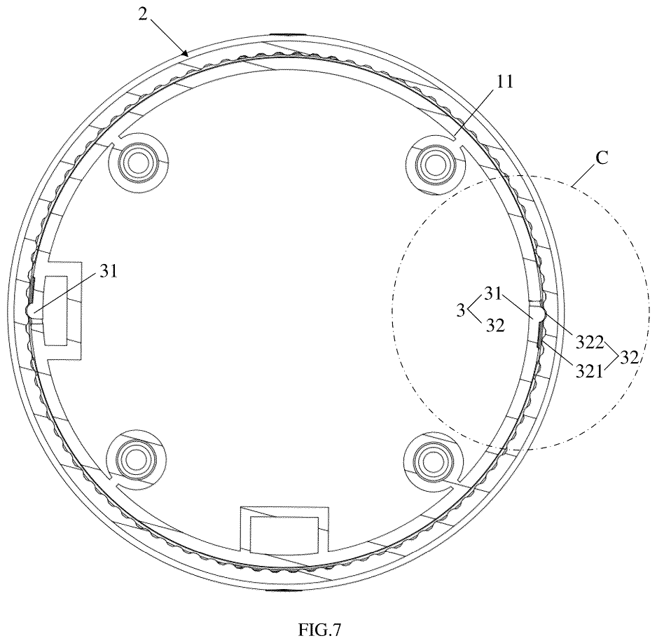

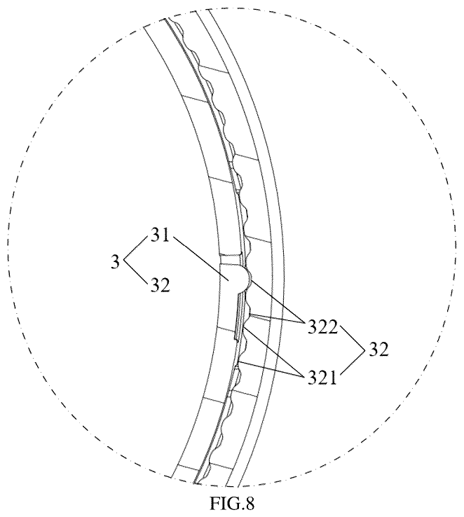

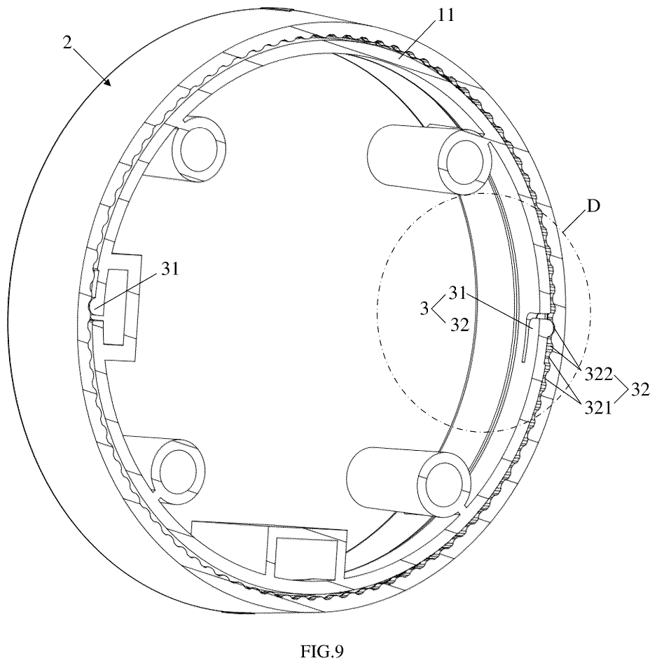

Please also refer to FIGS. 6-8. FIG. 6 is a schematic perspective view of the camera assembly 200 in accordance with at least one embodiment of the present disclosure from another view; FIG. 7 is a cross-sectional view of the front cover 2 and body housing 11 in FIG. 6 taken along a line B-B; FIG. 8 is an enlarged view of FIG. 7 taken along a circle C.

Specifically, as shown in FIGS. 7 and 8, when at least part of the end of the camera body 1 is mounted within the receiving space 21, the elastic snap-fit member 31 engages with at least some of the plurality of snap-fit grooves 32. When adjusting the angle of the camera body 1, the front cover 2 remains stationary while the camera body 1 is rotated, causing the camera body 1 to rotate within the receiving space 21. Due to the elasticity of the elastic snap-fit member 31, the elastic snap-fit member 31 sequentially engages with different snap-fit grooves 32 as the camera body 1 rotates, thereby positioning the camera body 1 at different angles relative to the front cover 2.

Each of the plurality of snap-fit grooves 32 may correspond to an angle setting. In at least one embodiment, users can feel the engagement action between the elastic snap-fit member 31 and the snap-fit grooves 32 to confirm that the angle adjustment of the camera body 1 is successful.

It should be understood that the angle through which the camera body 1 can rotate relative to the front cover 2 may be 180°, 360°, etc. This adjustable angle depends on the number of snap-fit grooves 32, without limited herein.

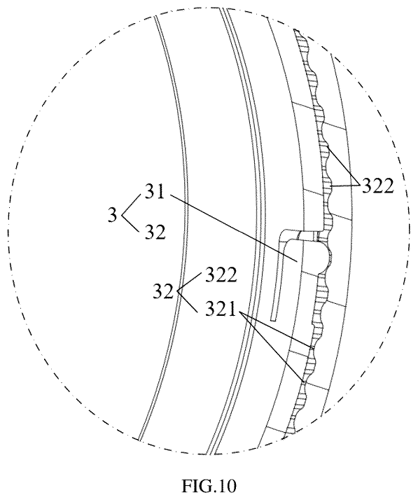

Please also refer to FIGS. 9 and 10. FIG. 9 is a perspective view of FIG. 7 from another view; FIG. 10 is an enlarged view of FIG. 9 taken along a circle D. Specifically, taking the example where the elastic snap-fit member 31 is located on the outer side of the camera body 1 and the plurality of snap-fit grooves 32 are defined on the inner sidewall of the front cover 2, as shown in FIGS. 9 and 10, only one end of the elastic snap-fit member 31 is connected to the outer side of the camera body 1, while the rest of the elastic snap-fit member 31 is suspended to form an elastic state that can be pressed into the camera body 1.

In at least one embodiment, as shown in FIGS. 9 and 10, each of the plurality of snap-fit grooves 32 may include two side engagement portions 321, and the two side engagement portions 321 are spaced apart, a recess 322 is formed between the two side engagement portions 321. The two side engagement portions 321 and the recess 322 together form the snap-fit groove 32. Specifically, the two side engagement portions 321 themselves protrude from the inner sidewall of the front cover 2 or the outer side of the camera body 1. Due to the spacing between the two protruding side engagement portions 321, the middle section between the two side engagement portions 321 is recessed relative to the side engagement portions 321, forming the recess 322.

Therefore, when the elastic snap-fit member 31 engages with different snap-fit grooves 32, the elastic snap-fit member 31 is located within the recess 322 of each snap-fit groove 32. The elastic snap-fit member 31 is pressed by the side engagement portions 321, exhibiting elastic behavior, allowing it to move from the recess 322 of one snap-fit groove 32 to another recess 322 of another snap-fit groove 32. This enables the camera body 1 to rotate to different angles relative to the front cover 2, allowing independent adjustment of the angle of the camera body 1 within the camera assembly 200 without needing to remove the camera assembly 200 to adjust its overall angle. This makes it more convenient for users to mount and use the camera assembly 200, saving time and effort while enhancing user experience and satisfaction.

In at least one embodiment, as shown in FIG. 9, the plurality of snap-fit grooves 32 are connected to form a ring-shaped area.

Therefore, the formation of the ring-shaped area allows the elastic snap-fit member 31 to engage with more snap-fit grooves 32, enabling the camera body 1 to rotate 360° within the receiving space 21, which increases the range of adjustable angles for the camera body 1, further facilitating user mounting and use of the camera assembly 200.

The connection of the plurality of snap-fit grooves 32 is achieved through the connection between the side engagement portions 321 of adjacent snap-fit grooves 32.

In other embodiments, the plurality of snap-fit grooves 32 may be divided into a plurality of segments along the circumference of the front cover 2, with the snap-fit grooves 32 in each segment connected to form a plurality of arc-shaped areas. In this case, the snap-fit structure 3 composed of the plurality of snap-fit grooves 32 and the elastic snap-fit member 31 only allows the camera body 1 to rotate within a limited angle range, unlike the 360° rotation described above.

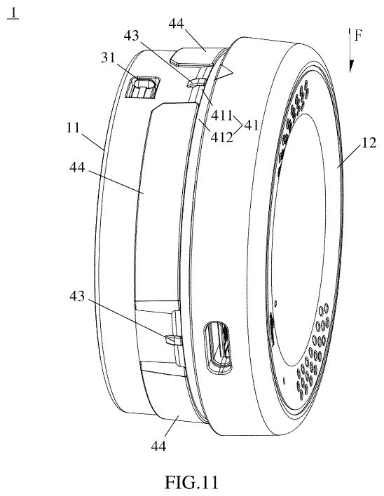

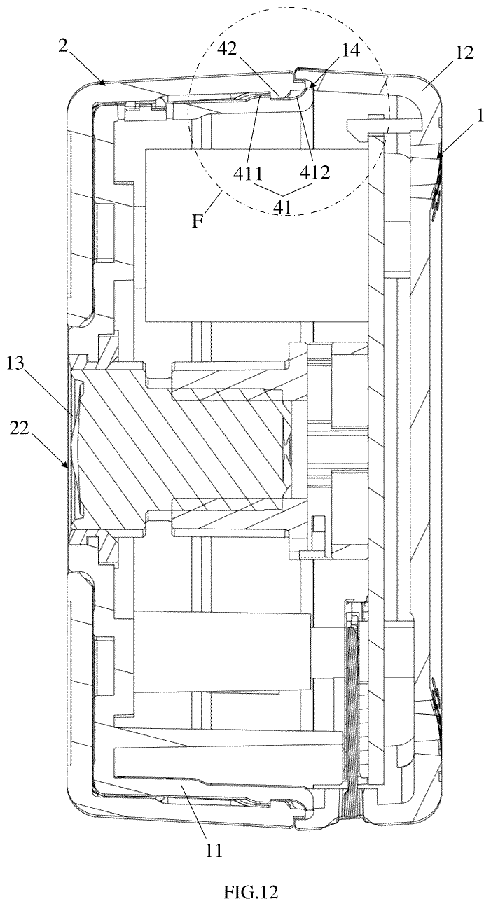

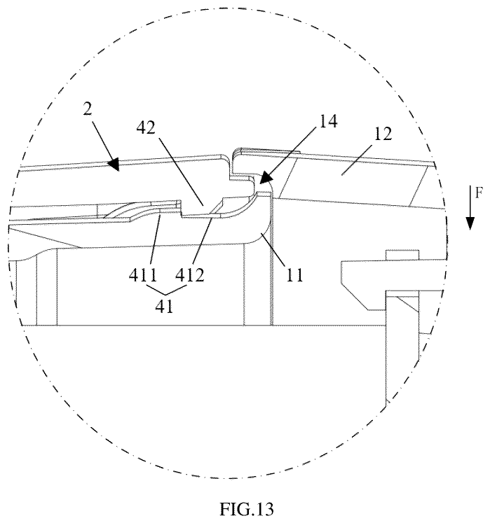

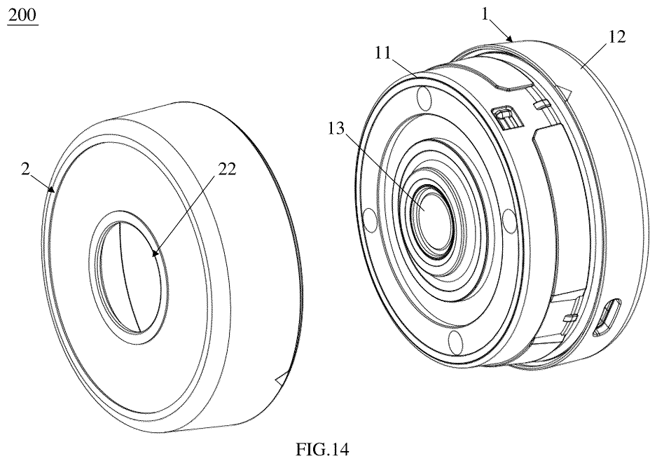

Please also refer to FIGS. 11-13. FIG. 11 is a schematic perspective view of the camera body 1 in accordance with at least one embodiment of the present disclosure; FIG. 12 is a cross-sectional view of FIG. 3 taken along a line E-E; FIG. 13 is an enlarged view of FIG. 12 taken along a circle F. In at least one embodiment, as shown in FIGS. 11 and 12, a step structure 4 is also formed at the junction of the camera body 1 and the front cover 2. The step structure 4 may include a step portion 41 and a latch portion 42. When the step portion 41 and the latch portion 42 engage, the camera body 1 and the front cover 2 are connected. When the step portion 41 and the latch portion 42 are disengaged from each other, the camera body 1 and the front cover 2 are separated.

Therefore, the camera body 1 and the front cover 2 are connected via the step structure 4, securing the camera body 1 within the receiving space 21, which further enhances the stability of the camera body 1 within the receiving space 21, preventing wobbling or detachment from the front cover 2 during angle adjustment, thus making it more convenient for users to mount and use the camera assembly 200, and improving user experience and satisfaction.

In at least one embodiment, the step portion 41 is located on the outer side of the camera body 1, and the latch portion 42 is located on the inner sidewall of the front cover 2.

Therefore, the step portion 41 on the outer side of the camera body 1 engages with the latch portion 42 on the inner sidewall of the front cover 2, securing the camera body 1 within the receiving space 21, which further enhances the stability of the camera body 1 within the receiving space 21, preventing wobbling or detachment from the front cover 2 during angle adjustment. This makes it more convenient for users to mount and use the camera assembly 200, improving user experience and satisfaction.

In at least one embodiment, the step portion 41 is located on the inner sidewall of the front cover 2, and the latch portion 42 is located on the outer side of the camera body 1.

Therefore, the step portion 41 on the inner sidewall of the front cover 2 engages with the latch portion 42 on the outer side of the camera body 1, securing the camera body 1 within the receiving space 21, which further enhances the stability of the camera body 1 within the receiving space 21, preventing wobbling or detachment from the front cover 2 during angle adjustment, thus making it more convenient for users to mount and use the camera assembly 200, and improving user experience and satisfaction.

In at least one embodiment, as shown in FIGS. 11 and 12, the step portion 41 may include a protruding portion 411 and a mounting portion 412. The mounting portion 412 is recessed relative to the protruding portion 411 along the radial direction of the camera body 1. The latch portion 42 located at the mounting portion 412 engages with the protruding portion 411, thereby connecting the step portion 41 and the latch portion 42. The protruding portion 411 is smoothly shaped in a direction F from the latch portion 42 to the step portion 41.

Specifically, as shown in FIGS. 12 and 13, the latch portion 42 passes over the protruding portion 411 and reaches the mounting portion 412. Since the protruding portion 411 has a certain height, the latch portion 42 is subjected to a compressive force from the protruding portion 411, causing it to lift radially outward along the front cover 2 by a certain height. When the latch portion 42 reaches the mounting portion 412, since the mounting portion 412 is recessed relative to the protruding portion 411, the latch portion 42 returns to its initial state. At this point, due to the protruding height of the protruding portion 411, the latch portion 42 is secured in the mounting portion 412, thereby mounting the camera body 1 within the receiving space 21.

Therefore, the camera body 1 and the front cover 2 are connected via the step structure 4, securing the camera body 1 within the receiving space 21, and further enhancing the stability of the camera body 1 within the receiving space 21, preventing wobbling or detachment from the front cover 2 during angle adjustment. Additionally, the smooth shape of the protruding portion 411 in the direction F from the latch portion 42 to the step portion 41 allows the latch portion 42 to smoothly transition from other positions over the protruding portion 411 into the mounting portion 412, improving the ease and smoothness of engagement between the step portion 41 and the latch portion 42.

Specifically, the smooth shape applies only to the protruding surface of the protruding portion 411. Taking the example where the step portion 41 is located on the outer side of the camera body 1 and the latch portion 42 is located on the inner sidewall of the front cover 2, the height of the protruding portion 411 on the outer side of the camera body 1 gradually increases in the direction F from the latch portion 42 to the step portion 41, allowing the latch portion 42 to smoothly transition from other positions over the protruding portion 411 into the mounting portion 412.

It should be understood that the front cover 2 may be made of, but is not limited to, a mixture of polycarbonate (PC) and acrylonitrile-butadiene-styrene copolymer (ABS), as long as it has a certain elasticity, ensuring that the latch portion 42 can be lifted radially outward along the front cover 2 by a certain height when pressed and return to its initial state when reaching the mounting portion 412, without limited herein.

In at least one embodiment, as shown in FIG. 11, the step portion 41 is ring-shaped.

Therefore, the step portion 41 is ring-shaped, and the mounting portion 412 and protruding portion 411 are ring-shaped, and the ring-shaped mounting portion 412 provides a rotational track for the latch portion 42, so when the angle of the camera body 1 is adjusted via the snap-fit structure 3, the step portion 41 rotates relative to the latch portion 42, ensuring the latch portion 42 does not hinder the rotation of the camera body 1. Additionally, the step portion 41 is ring-shaped, allowing the camera body 1 to rotate over a larger angle range relative to the front cover 2.

In other embodiments, the step portion 41 may be divided into a plurality of segments along the circumference of the camera body 1. In this case, when adjusting the angle of the camera body 1 via the snap-fit structure 3, the limited rotational path provided by the segmented mounting portion 412 restricts the camera body 1 to rotating within a certain angle range, unlike the 360° rotation described above.

In at least one embodiment, the latch portion 42 does not contact the mounting portion 412, preventing friction between them during rotation and avoiding hindrance to the rotation of the camera body 1.

In at least one embodiment, there are a plurality of latch portions 42, with equal spacing between every two latch portions 42.

Therefore, the plurality of latch portions 42 provide a more secure connection between the front cover 2 and the camera body 1, further enhancing the stability of the camera body 1 within the receiving space 21. Additionally, the even distribution of the latch portions 42 ensures smoother rotation of the camera body 1 within the receiving space 21, preventing tilting or jamming.

In at least one embodiment, as shown in FIGS. 12 and 13, the part of the mounting portion 412 in the body housing 11 away from the protruding portion 411 gradually increases in thickness in the direction F from the latch portion 42 to the step portion 41, which forms a mounting gap 14 with the part of the body cover 12 on the body housing 11, for accommodating the end of the front cover 2 close the body cover 12, further enhancing the stability of the camera body 1 within the receiving space 21.

In at least one embodiment, as shown in FIGS. 4 and 5, the latch portion 42 may include a first latch 421 and a second latch 422. The first latch 421 and the second latch 422 are spaced apart to form a gap 423 between them. As shown in FIG. 11, the step portion 41 may also include a positioning portion 43 corresponding to the gap 423, configured to position the engagement position of the latch portion 42 on the step portion 41.

Therefore, the positioning portion 43 positions the engagement position of the latch portion 42 on the step portion 41, ensuring that the latch portion 42 is mounted at the designated position on the step portion 41. Additionally, the positioning portion 43 prevents the latch portion 42 from disengaging from the mounting portion 412, improving the stability of the engagement between the step portion 41 and the latch portion 42 and further enhancing the stability of the camera body 1 within the receiving space 21.

In at least one embodiment, as shown in FIG. 11, at least part of the positioning portion 43 is located on the protruding portion 411, configured to position the engagement position of the latch portion 42 on the step portion 41. The positioning portion 43 is smoothly shaped in the direction F from the latch portion 42 to the step portion 41.

Therefore, the positioning portion 43 on the protruding portion 411 ensures the latch portion 42 engages more accurately at the designated position on the step portion 41. The smooth shape of the positioning portion 43 in the direction F from the latch portion 42 to the step portion 41 allows the latch portion 42 to smoothly transition from other positions over the protruding portion 411 and positioning portion 43 into the mounting portion 412, improving the ease and smoothness of engagement between the step portion 41 and the latch portion 42.

Specifically, the smooth shape applies only to the protruding surface of the positioning portion 43. Taking the example where the step portion 41 is located on the outer side of the camera body 1 and the latch portion 42 is located on the inner sidewall of the front cover 2, the height of the positioning portion 43 on the outer side of the camera body 1 gradually increases in the direction F from the latch portion 42 to the step portion 41, allowing the latch portion 42 to smoothly transition from other positions over the protruding portion 411 into the mounting portion 412.

In at least one embodiment, as shown in FIG. 11, a plurality of protruding strips 44 are located on the body housing 11, spaced apart and arranged around the outer side of the body housing 11. Some of the protruding strips 44 are located on the protruding portion 411, ensuring the latch portion 42 can only engage with the step portion 41 at the gaps between the protruding strips 44. Thus, the positioning portion 43 more precisely positions the engagement position of the latch portion 42 on the step portion 41, guiding the engagement between the latch portion 42 and the step portion 41.

Please refer to FIG. 14. FIG. 14 is an exploded view of FIG. 6. In at least one embodiment, the camera body 1 may include a camera lens 13. The camera body 1 defines a body cavity, and the camera lens 13 is mounted within the body cavity, with at least part of the camera lens 13 exposed on the outer side of the camera body 1. The front cover 2 defines a light-transmitting area 22 corresponding to the exposed part of the camera lens 13, allowing the camera lens 13 to receive light rays through the light-transmitting area 22.

Therefore, the light-transmitting area 22 on the front cover 2 exposes the camera lens 13, enabling the camera lens 13 to receive light rays and perform imaging or other operations on the external environment.

It should be understood that the light-transmitting area 22 may be a through-hole corresponding to the exposed part of the camera lens 13 or a glass area, as long as it allows the camera lens 13 to receive light rays, without limited herein.

Above of all, when the substrate 400 is a light-transmitting substrate, the camera assembly 200 is fixed on one side of the substrate, with the camera lens 13 facing the substrate 400, allowing the camera lens 13 to image or photograph scenes on the other side of the substrate 400 through the light-transmitting substrate. If the angle of the camera lens 13 is not at the standard imaging angle, the camera body 1 can be rotated via the snap-fit structure 3 to adjust the angle of the camera lens 13 to the standard imaging angle.

When the substrate 400 is a non-light-transmitting substrate, the camera assembly 200 is still fixed on the substrate 400, but the camera lens 13 faces away from the substrate 400, allowing the camera lens 13 to directly image or photograph scenes without the substrate 400 in between. If the angle of the camera lens 13 is not at the standard imaging angle, the camera body 1 can be rotated via the snap-fit structure 3 to adjust the angle of the camera lens 13 to the standard imaging angle.

In summary, it is evident that the present disclosure possesses the aforementioned advantageous characteristics, enabling it to achieve unprecedented effectiveness in use, making it a highly practical product with significant value.

The above description merely outlines specific implementations of the present disclosure, but the scope of protection is not limited thereto. Any modifications or replacements that can be easily conceived by those skilled in the art within the technical scope disclosed in the present disclosure shall fall within the scope of protection of the present disclosure. In cases of no conflict, the embodiments of the present disclosure and their features may be combined. Therefore, the scope of protection of the present disclosure shall be defined by the claims.

What is claimed is:

1. A camera assembly, wherein comprising:
a camera body; and
a front cover defining a receiving space, at least part of one end of the camera body being mounted within the receiving space;
wherein a snap-fit structure is provided at a junction of the camera body and the front cover; the snap-fit structure comprises an elastic snap-fit member and a plurality of snap-fit grooves arranged peripherally around the camera assembly; when the elastic snap-fit member engages with different snap-fit grooves, the camera body is positioned at different angles relative to the front cover.

2. The camera assembly according to claim 1, wherein: the elastic snap-fit member is located on an outer side of the camera body, and the plurality of snap-fit grooves are defined on an inner sidewall of the front cover.

3. The camera assembly according to claim 1, wherein: the elastic snap-fit member is located on an inner sidewall of the front cover, and the plurality of snap-fit grooves are defined on an outer side of the camera body.

4. The camera assembly according to claim 1, wherein: each of the plurality of snap-fit grooves comprises two side engagement portions, the two side engagement portions are spaced apart, a recess is formed between the two side engagement portions; the two side engagement portions and the recess cooperatively form the snap-fit groove.

5. The camera assembly according to claim 1, wherein: the plurality of snap-fit grooves are connected to form a ring-shaped area.

6. The camera assembly according to claim 1, wherein: a step structure is also formed at the junction of the camera body and the front cover; the step structure comprises a step portion and a latch portion;
when the step portion and the latch portion engage, the camera body and the front cover are connected;
when the step portion and the latch portion are disengaged from each other, the camera body and the front cover are separated.

7. The camera assembly according to claim 6, wherein: the step portion is located on an outer side of the camera body, and the latch portion is located on an inner sidewall of the front cover.

8. The camera assembly according to claim 6, wherein: the step portion is located on an inner sidewall of the front cover, and the latch portion is located on an outer side of the camera body.

9. The camera assembly according to claim 6, wherein: the step portion comprises a protruding portion and a mounting portion; the mounting portion is recessed relative to the protruding portion; the latch portion located at the mounting portion engages with the protruding portion, thereby connecting the step portion and the latch portion; the protruding portion is smoothly shaped in a direction from the latch portion to the step portion.

10. The camera assembly according to claim 9, wherein: the latch portion comprises a first latch and a second latch; the first latch and the second latch are spaced apart to form a gap between them, the step portion further comprises a positioning portion, the positioning portion is located correspondingly to the gap, configured to position an engagement position of the latch portion on the step portion.

11. The camera assembly according to claim 10, wherein: at least part of the positioning portion is located on the protruding portion, configured to position the engagement position of the latch portion on the step portion; the positioning portion is smoothly shaped in the direction from the latch portion to the step portion.

12. The camera assembly according to claim 6, wherein: the step portion is ring-shaped.

13. The camera assembly according to claim 12, wherein: there are a plurality of the latch portions, with equal spacing between every two latch portions of the plurality of the latch portions.

14. The camera assembly according to claim 1, wherein: the camera body comprises a camera lens, the camera body defines a body cavity, the camera lens is mounted within the body cavity, at least part of the camera lens is exposed on an outer side of the camera body; the front cover defines a light-transmitting area corresponding to the exposed part of the camera lens; the camera lens receives light rays through the light-transmitting area.

15. An imaging apparatus, comprising:
a camera assembly according to claim 1;
a fixing member mounted on an outer side of the front cover, to secure the camera assembly to a substrate.
